(19) United States
(12) Patent Application Publication
(10) Pub. No.: US 2026/0236623 A1
(43) Pub. Date: Aug. 13, 2026

(54) PHYSICAL INTRUSION DETECTION MODULE

(71) Applicant: HEWLETT PACKARD ENTERPRISE DEVELOPMENT LP, Spring, TX (US)

(72) Inventor: Luis E. Luciani, JR., Tomball, TX (US)

(21) Appl. No.: 18/919,628

(22) Filed: Oct. 18, 2024

(51) Int. Cl. G06F 21/86; G06F 21/44; G08B 13/06

(52) U.S. Cl. CPC G06F 21/86; G06F 21/44; G08B 13/06

(57) ABSTRACT

In some examples, an intrusion detection module includes a battery and a switch having a first state and a second state. The first state corresponds to a removable cover of an electronic device being closed, and the second state corresponds to the removable cover of the electronic device being open. The intrusion detection module includes an electronic chip having a counter, the counter to advance based on the switch transitioning from the first state to the second state to connect power from the battery to the electronic chip. The intrusion detection module includes a connector, where a count of the counter is accessible through the connector to a controller in the electronic device, the count when different from an expected value indicating an occurrence of a physical intrusion of the electronic device.

### BACKGROUND

Some electronic devices may include removable covers that can be opened, either by unlocking a latch or by removing fasteners that attach the covers to housings of the electronic devices. Maintenance personnel may access components inside an electronic device by removing a cover of the electronic device. A component inside the electronic device may be accessed for performing a maintenance action, including testing the component, visually inspecting the component, replacing the component, or another maintenance action.

### BRIEF DESCRIPTION OF THE DRAWINGS

Some implementations of the present disclosure are described with respect to the following figures.

FIG. 1 is a block diagram of an electronic device including a physical intrusion detection module, in accordance with some examples.

FIG. 2 is a flow diagram of an authentication process and an intrusion detection process, according to some examples.

FIG. 3 is a circuit diagram of an intrusion detection module according to some examples.

FIG. 4 is a timing diagram of states of various elements in an intrusion detection module, according to some examples.

FIG. 5 is a block diagram of an intrusion detection module according to some examples.

FIG. 6 is a block diagram of a management controller according to some examples.

FIG. 7 is a flow diagram of a process according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

An electronic device may include a physical intrusion sensor to detect a physical intrusion into the electronic device. In some cases, the physical intrusion may be an unauthorized physical intrusion. An unauthorized person may open a removable cover of the electronic device to tamper with components inside the electronic device. Tampering may include adding a new component inside the electronic device to perform unauthorized operations, such as to read data that is then transmitted to a remote device, interfere with legitimate operations of the electronic device, or cause an error or failure of the electronic device. To avoid detection, the unauthorized person may disable the physical intrusion sensor, such as by cutting a cable to the physical intrusion sensor, removing a cable from a connector of the physical intrusion sensor, powering off the electronic device before opening the cover, or any other disabling action. The cutting or removal of a cable of the physical intrusion sensor may be performed through any small opening in a housing of the electronic device. Once the cable is cut or removed, the physical intrusion sensor would not be able to detect the opening of the cover. If the electronic device is powered off, the unauthorized person can open the cover and then remove a battery that powers a memory that stores information indicating detected physical intrusions. When the battery is removed, any stored information indicating a physical intrusion would be lost. If a physical intrusion is undetected, then an enterprise operating the electronic device may not be aware that tampering with the electronic device has occurred that can result in data theft or other malicious activities.

In accordance with some implementations of the present disclosure, a tamper-resistant physical intrusion detection module includes a battery and a detector that is able to detect and track the opening of a cover of an electronic device. The detector includes a switch that is opened or closed based on whether the cover of the electronic device is closed or open. The detector further includes an electronic chip with a monotonic counter that advances in response to the cover opening and the switch closing. A monotonic counter does not reverse its count. The battery and the detector are contained within a package of the physical intrusion detection module so that the battery cannot be removed without also removing the physical intrusion detection module. Additionally, the switch of the physical intrusion detection module is mechanically linked to the cover. The switch has an open state and a closed state, and the state of the switch is dependent upon whether the cover is closed or open. In some examples, when the cover is closed, the switch remains in the open state and the battery is isolated from the detector. However, when the cover is opened (to allow access by a person to an inside space of the electronic device), the switch is actuated from the open state to the closed state, which connects power from the battery to the detector in the physical intrusion detection module. The counter of the electronic chip advances (increments or decrements) in response to an application of power to the electronic chip. The counter can track a quantity of times that the cover has been opened. A management controller of the electronic device is able to access the count of the counter to make a determination of whether a physical intrusion of the electronic device has occurred based on opening the cover.

The physical intrusion detection module is tamper resistant in that the intrusion detection module is not easily disabled by simply cutting or removing a cable. In addition, an internal battery of the intrusion detection module allows for detection of an intrusion even if the primary power supply of the electronic device is off. Also, if an attacker were to replace an electronic chip in the intrusion detection module with a different electronic chip, the different electronic chip would fail an authentication process initiated by the management controller.

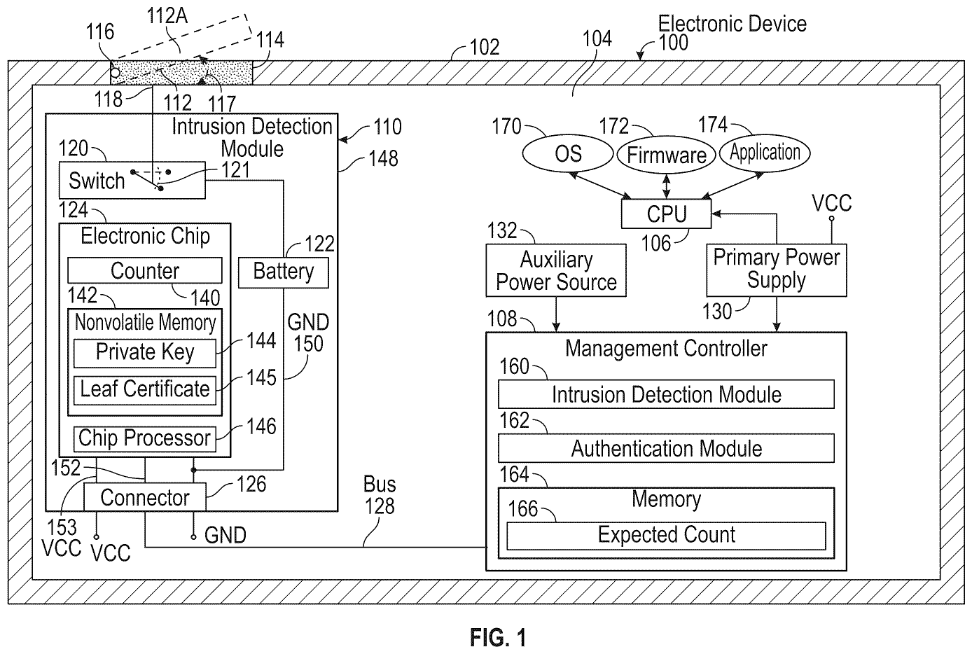

FIG. 1 is a block diagram of an electronic device 100 that includes a housing 102 defining an inner space 104 in which various components are placed. The components in the inner space 104 of the electronic device 100 include a central processing unit (CPU) 106, a management controller 108, a physical intrusion detection module 110, a primary power supply 130, and an auxiliary power source 132. In some examples, the management controller 108 includes a baseboard management controller (BMC).

A cover 112 is removably mounted to the housing 102 of the electronic device 100. The cover 112 can be in the form of a lid, a panel, or any other mechanical structure that if removed allows access through an opening 114 of the housing 102 into the inner space 104 of the electronic device 100. In some examples, the cover 112 is pivotally attached to the housing 102 at a pivot connection 116. The cover 112 can be moved (pivoted) between a closed position (in which the opening 114 is covered by the cover 112) and an open position (in which the opening 114 is exposed) along a pivoting axis 117. The cover when in the open position is represented as a dashed profile referenced by numeral 112A. When the opening 114 is exposed, a person can access the inner space 104 of the electronic device 100.

In other examples, the cover 112 can be a sliding cover that can be slid between an open position (in which the opening 114 is exposed), and a closed position (in which the opening 114 is covered). In yet further examples, the cover 112 can be lifted away from the housing 102 to expose the opening 114.

The cover 112 is mechanically connected by a link 118 to a switch 120 of the intrusion detection module 110. The switch 120 may be a mechanical switch or an electrical switch. The link 118 can be a mechanical link that actuates the switch 120 along axis 121 based on the physical position of the cover 112.

When the cover 112 is in the closed position (in which the opening 114 is covered), the switch 120 is in the open state. However, if the cover 112 is removed from the housing 102 to expose the opening 114, the mechanical link 118 causes actuation of the switch 120 to a closed state. In the open state, an electrical current cannot pass through the switch 120. However, in the closed state, electrical current can pass through the switch 120.

The intrusion detection module 110 further includes a battery 122, an electronic chip 124, and a connector 126. The intrusion detection module 110 includes a physical package 148 that houses the components of the intrusion detection module 110. The package 148 can be a plastic housing, a metal housing, or any other housing that protects the components inside the intrusion detection module 110 from physical access.

The connector 126 includes various connection contacts, such as pins, receptacles, or other types of electrical elements. The connector 126 has bus connection contacts that connect to a management bus 128. In some examples, the management bus 128 is an I²C (Inter-Integrated Circuit) used for communicating management data as part of management operations of the management controller 108. In other examples, other types of management buses can be employed, such as a Serial Peripheral Interface (SPI) bus or another type of bus. The management bus 128 is separate from other input/output (I/O) bus(es) of the electronic device 100, such as I/O bus(es) to transfer data of processes executed by the CPU 106 or to perform other types of communications.

The management controller 108 is connected over the management bus 128 to the connector 126 of the intrusion detection module 110. The connector 126 also includes power connection contacts that connect to power signals, including VCC and GND. VCC is a power supply voltage provided by the primary power supply 130 of the electronic device 100. The primary power supply 130 can generate one or more power supply voltages, including VCC to power various components of the electronic device 100, including the CPU 106, the management controller 108, and other electronic components in the electronic device 100. GND is a ground signal connected to a ground plane of the electronic device 100.

Further, the auxiliary power source 132 (e.g., including a battery) supplies power to the management controller 108 when the primary power supply 130 is off, such as when the electronic device 100 is placed in a powered off state. In some examples, the auxiliary power source 132 includes a battery. The auxiliary power source 132 supplies power to the management controller 108 in case power is not available from the primary power supply 130, to allow the management controller 108 to continue to operate even when the electronic device 100 is powered off.

When the electronic device 100 is powered on, the primary power supply 130 can supply VCC to the intrusion detection module 110. The battery 122 in the intrusion detection module 110 is an independent power source that is distinct and separate from other power sources (including the primary power supply 130 and the auxiliary power source 132) of the electronic device 100. The presence of this independent power source allows the intrusion detection module to detect and record physical intrusions due to opening of the cover 112, regardless of whether VCC is supplied to the intrusion detection module 110.

Within the intrusion detection module 110, the GND connection contact of the connector 126 is connected over a GND line 150 to the battery 122 and the electronic chip 124. The bus connection contacts of the connector 126 are connected over a bus line 152 to the electronic chip 124. The VCC connection contact of the connector 126 is connected over a VCC line 153 to the electronic chip 124.

The electronic chip 124 can be implemented using a programmable integrated circuit device, a programmable gate array, a programmable logic device, or any other type of hardware processing circuitry. The electronic chip 124 includes a counter 140 that advances (increments or decrements) in response to a detection of an opening of the cover 112. In some examples, the counter 140 is initialized to zero or another low initial value. In response to detecting each opening of the cover 112, the counter 140 increments. In other examples, the counter 140 can be initialized to an initial high value, with the counter 140 decrementing in response to detecting each opening of the cover 112.

The electronic chip 124 further includes a nonvolatile memory 142 that is able to maintain stored data even if power is removed from the electronic chip 124. In some examples, the counter 140 is part of the nonvolatile memory 142. In other examples, the counter 140 is separate from the nonvolatile memory 142.

The nonvolatile memory 142 can also store a private key 144 that can be used to sign a value provided by the management controller 108 as part of an authentication process performed between the management controller 108 and the electronic chip 124 to authenticate the electronic chip 124. In other examples, the nonvolatile memory 142 can store a secret that is different from or in addition to the private key 144, where the secret is used as part of the authentication process between the management controller 108 and the electronic chip 124. The authentication process is performed over the management bus 128. Additionally, the nonvolatile memory 142 can also store a leaf certificate 145, which is also used as part of the authentication process. The leaf certificate 145 can include a public key that can be used to decrypt (e.g., at the management controller 108) a signed value produced using the private key 144. The public key and private key form a public-private key pair. The leaf certificate 145 may be provisioned in the electronic chip 124 during manufacture of the electronic chip 124, for example.

The electronic chip 124 further includes a chip processor 146 that performs various tasks of the electronic chip 124, including responding to queries from the management controller 108, performing an authentication process, or any other tasks.

A query submitted from the management controller 108 over the management bus 128 can request the count of the counter 140. The management controller 108 includes an intrusion detection module 160, which performs a determination of whether a physical intrusion has occurred with respect to the electronic device 100 based on the count obtained from the electronic chip 124.

The intrusion detection module 160 compares the count obtained from the electronic chip 124 to an expected count 166 stored in a memory 164 of the management controller 108. For example, the expected count 166 can be zero if no physical intrusion of the inner space 104 of the electronic device 100 is expected. In another example, the expected count 166 can be a non-zero value if authorized personnel have opened the cover 112 to access components in the inner space 104 of the electronic device 100, such as to perform maintenance action(s). If the intrusion detection module 160 determines based on the comparison that the count obtained from the electronic chip 124 exceeds the expected count 166, the intrusion detection module 160 can issue an intrusion alert

The management controller 108 also includes an authentication module 162 to perform an authentication process with the electronic chip to authenticate the electronic chip 124. The modules 160 and 162 can be implemented as part of the hardware processing circuitry of the management controller 108, or as machine-readable instructions executed by the management controller 108.

The authentication process performed by the authentication module 162 is to check that the electronic chip 124 has not been replaced with a different part, such as by an attacker that has access to the intrusion detection module 110 to physically replace the original electronic chip 124 with a different electronic chip.

The CPU 106 executes primary instructions of the electronic device 100. The primary instructions include an operating system (OS) 170, system firmware 172 (e.g., Basic Input/Output System (BIOS) code), and/or an application program 174. The primary machine-readable instructions are distinct from management machine-readable instructions executed by the management controller 108, for example.

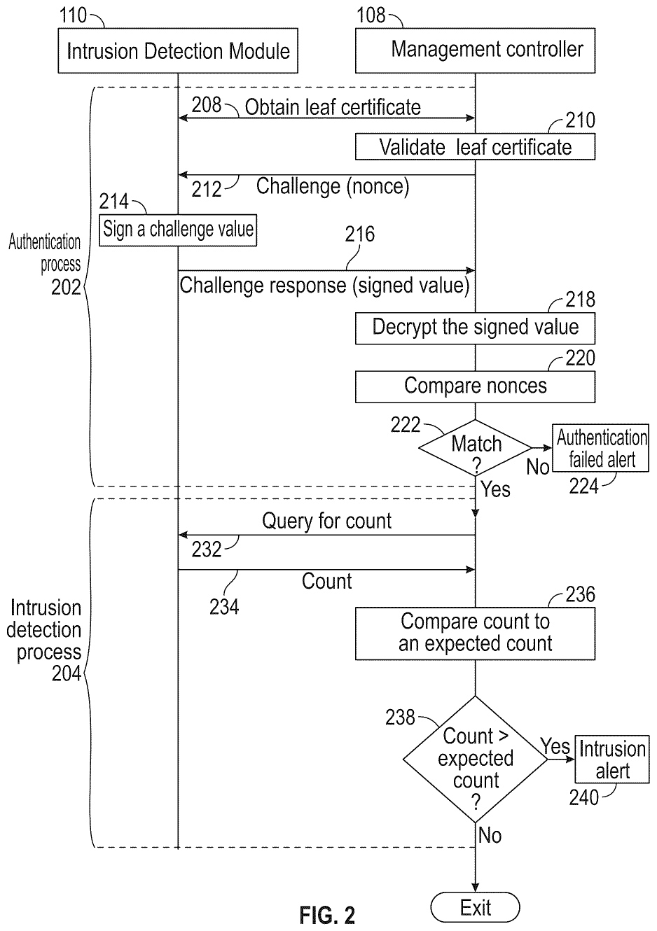

FIG. 2 is a flow diagram illustrating processes between the management controller 108 and the intrusion detection module 110. The processes can be initiated by the management controller 108 on a periodic basis or in response to events, such as a power-on event relating to powering on the electronic device 100. Although FIG. 2 shows a sequence of tasks, it is noted that in other examples, the tasks may be performed in a different order, some tasks may be omitted, and additional tasks may be added.

The authentication module 162 of the management controller 108 can initiate an authentication process 202 to authenticate the electronic chip 124 in the intrusion detection module 110. The authentication process 202 includes tasks 212-224.

The authentication process 202 includes the management controller 108 obtaining (at 208) the leaf certificate 145 from the electronic chip 124. The management controller 108 can send a request to the electronic chip 124 for the leaf certificate 145, and the electronic chip 124 responds by sending the leaf certificate 145 to the management controller 108. The management controller 108 validates (at 210) the leaf certificate 145 to ensure that the leaf certificate 145 (and thus keys associated with the leaf certificate 145) was issued by a trusted entity. For example, the management controller 108 can check that the leaf certificate 145 is current and has not been revoked. The validation of the leaf certificate 145 (which is signed by a certificate authority) can be based on the certificate authority's public key that is stored at the management controller 108.

Assuming that the leaf certificate 145 has been validated, the management controller 108 sends (at 212) a challenge to the electronic chip 124 over the management bus 128. The challenge can include a nonce, which is a random number. In other examples, other types of values can be sent by the management controller 108 as part of the challenge.

In response to receiving the challenge, the chip processor 146 in the intrusion detection module 110 signs (at 214) a challenge value that includes the nonce and possibly one or more other values). Signing the challenge value refers to encrypting the challenge value with the private key 144 of the intrusion detection module 110. The signing of the challenge value produces a signed value.

The chip processor 146 sends (at 216) a challenge response to the management controller 108 over the management bus 128. The challenge response includes the signed value.

The authentication module 162 in the management controller 108 decrypts (at 218) the signed value using the public key that corresponds to the private key 144. The public key is extracted from the leaf certificate 145. The decryption of the signed value produces a nonce and possibly one or more other values. The authentication module 162 compares (at 220) the nonce produced by the decryption to the nonce sent in the challenge to the electronic chip 124.

If the nonces do not match, as determined (at 222), then the electronic chip 124 is not authenticated. In response, the authentication module 162 can issue (at 224) an authentication failed alert, which can be in the form of a message, a signal, an information element, or another indicator, to indicate that the electronic chip 124 is not authentic.

If the nonces match, as determined (at 222), then the electronic chip 124 has been successfully authenticated, and the management controller, the management controller 108 can proceed to initiate an intrusion detection process 204. The intrusion detection process 204 includes tasks 232-240.

The intrusion detection module 160 in the management controller 108 sends (at 232) a query to the electronic chip 124 over the management bus 128, where the query seeks the count of the counter 140. The query can be in the form of a message, a signal, an information element, or any other indicator. In response to the query, the chip processor 146 in the intrusion detection module 110 retrieves and sends (at 234) the count of the counter 140 to the management controller 108 over the management bus 128.

The intrusion detection module 160 compares (at 236) the count obtained from the electronic chip 124 to the expected count 166 stored in the memory 164 of the management controller 108. If the intrusion detection module 160 determines (at 238) based on the comparison that the count obtained from the electronic chip 124 does not exceed the expected count 166, the intrusion detection module 160 exits the intrusion detection process 204.

If the intrusion detection module 160 determines (at 238) based on the comparison that the count obtained from the electronic chip 124 exceeds the expected count 166, the intrusion detection module 160 can issue (at 240) an intrusion alert, which can be in the form of a message, a signal, an information element, or any other indicator.

The authentication failed alert or the intrusion alert can be sent to a target entity in the electronic device 100 or outside the electronic device 100. The target entity can then perform a remediation action, including notifying a human administrator or a program or machine, disabling the electronic device 100, disabling a network connectivity of the electronic device 100, or any other remediation action to protect the electronic device 100 from further damage or unauthorized access.

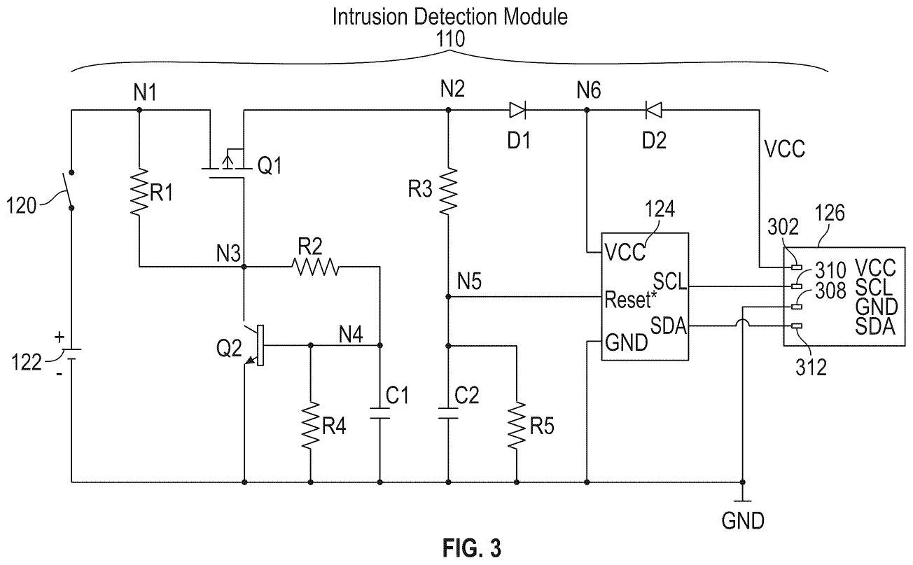

FIG. 3 is a circuit diagram of the intrusion detection module 110, according to some examples of the present disclosure. Although a specific arrangement of circuit components is shown in FIG. 3, in other examples, some of the circuit components may be omitted, or other circuit components may be added.

The ensuing discussion refers to FIG. 1 and FIG. 3. The switch 120 is shown in the open state, which corresponds to the cover 112 being in the closed position. If the cover 112 is moved to the open position, then the switch 120 is transitioned to the closed state.

The switch 120 is connected between the positive terminal of the battery 122 and node N1. The negative terminal of the battery 122 is connected to ground (GND). Transistor Q1 is connected between nodes N1 and N2. In some examples, transistor Q1 is a field effect transistor (FET). In other examples, transistor Q1 can be a different type of transistor, such as bipolar junction transistor (BJT). The gate of transistor Q1 is connected to node N3. When node N3 is high, transistor Q1 is activated to electrically connect nodes N1 and N2. On the other hand, if node N3 is low, then transistor Q1 is deactivated, which electrically isolates nodes N1 and N2.

A node being “high” refers to the node being at an elevated voltage (e.g., VCC or some voltage less than VCC but higher than or equal the activation voltage used to activate a transistor). A node being “low” refers to the node being at GND or a low voltage that is less than the activation voltage used to activate a transistor.

Resistor R1 is a charging resistor connected between nodes N1 and N3, and resistor R2 is connected between nodes N3 and N4. When the switch 120 is actuated to the closed state (due to the cover 112 opening), node N3 is driven high through charging resistor R1.

Capacitor C1 and resistor R4 are connected in parallel between node N4 and GND. Resistor R4 is a discharging resistor to discharge the voltage of capacitor C1 when the switch 120 is in the open state (due to the cover 112 being closed).

Node N4 is connected to the base of transistor Q2, which in some examples is a BJT. In other examples, transistor Q2 can be replaced with an FET. When node N4 is driven high, transistor Q2 is activated. If node N4 is low, then transistor Q2 is deactivated.

Resistors R1, R2, and R4 form a voltage divider. When the switch 120 is closed, the voltage at node N4 is dependent upon the combined resistance of resistors R1 and R2 and the resistance of resistor R4. Assuming the voltage of the battery 122 is V_{BAT} and the switch 120 is closed, then the voltage at node N4 is as follows:

$${V}_{N 4} = ( R 4 / ( R 1 + R 2 + R 4 ) ) \cdot {V}_{BAT .}$$

A higher resistance of resistor R4 will cause V_{N4} to be higher. In some examples, the resistance of resistor R4 can be at least 10 times (or some other factor) the combined resistance of R1 and R2.

Resistor R3 is connected between node N2 and node N5, which is connected to a Reset* input of the electronic chip 124. In the example shown, Reset* is an active low input, which means if Reset* is asserted low, the electronic chip 124 is maintained in a reset state (non-operational), but if Reset* is de-asserted high, the electronic chip 124 is released from the reset state (operational).

Capacitor C2 and resistor R5 are connected in parallel between node N5 and GND. Resistor R5 is a discharging resistor to discharge the voltage of capacitor C2 when transistor Q1 is deactivated.

Resistors R3 and R5 form a voltage divider. When the switch 120 is closed and transistor Q1 is activated, the voltage at node N4 is dependent upon the resistance of resistor R3 and the resistance of resistor R4. Assuming the switch 120 is closed and transistor Q1 is activated, then the voltage at node N5 is as follows:

$${V}_{N 5} = ( R 5 / ( R 3 + R 5 ) ) \cdot {V}_{BAT .}$$

A higher resistance of resistor R5 will cause V_{N5} to be higher. In some examples, the resistance of resistor R5 can be at least 10 times (or some other factor) the resistance of R3.

Diode D1 is connected between node N2 and node N6. The cathode of diode D1 is connected to node N6, and the anode of diode D1 is connected to node N2. Diode D1 is activated to conduct electrical current if the voltage at node N2 exceeds the voltage at node N6 by more than the threshold voltage of diode D1. Node N6 is connected to the VCC input of the electronic chip 124. A GND input of the electronic chip 124 is connected to GND.

Diode D2 is connected between node N6 and a VCC contact 302 of the connector 126. GND is connected to a GND contact 308 of the connector 126. In examples where the management bus 128 is an I²C bus, the connector 126 additionally includes an SCL contact 310 and an SDA contact 312. An SCL pin of the electronic chip 124 is connected to the SCL contact 310 of the connector 126, and an SDA pin of the electronic chip 124 is connected to the SDA contact 312 of the connector 126. STA represents the serial data line of the I²C bus, and SCL represents the serial clock line of the I²C bus.

Diode D2 turns on if VCC is applied and exceeds the voltage at node N6 by greater than the threshold voltage of diode D2. VCC is applied if power were supplied to the VCC contact 302 of the connector 126 by the primary power supply 130. However, if VCC is not applied, then diode D2 is deactivated.

As noted above, the electronic chip 124 includes the counter 140 that advances in response to the cover 112 opening, which causes the switch 120 to close. In a first example, it is assumed that power is not provided to the VCC contact 302 of the connector 126. In this first example, while the cover 112 of the electronic device 100 is closed (and the switch 120 is in the open state), the electronic chip 124 remains powered off.

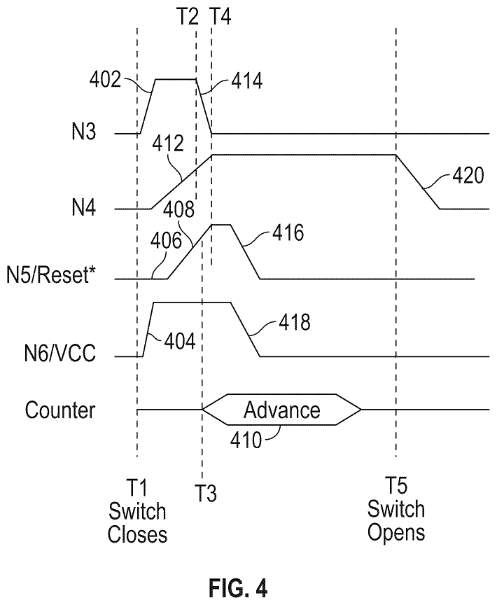

The following refers to FIG. 3 and FIG. 4. FIG. 4 is a timing diagram of various nodes of the intrusion detection module 110. The cover 112 is opened, which actuates the switch 120 to the closed state at time T1. When the switch 120 is in the closed state, the battery 122 supplies an electrical current through the switch 120 and resistor R1 to drive (at 402) node N3 high. The battery 122 charges capacitor C1 through resistors R1 and R2, to a voltage determined by the voltage divider formed by resistors R1, R2, and R4.

In addition, driving node N3 high turns on transistor Q1, which connects the battery voltage, V_{BAT}, to node N2 through transistor Q1. As a result, diode D1 turns on, and node N6 (connected to the VCC input of the electronic chip 124) is driven (at 404) to V_{BAT} less the threshold voltage of diode D1. As a result, the electronic chip 124 is powered on.

Although the electronic chip 124 is powered on, node N5 is still initially low (at 406), due to initially being pulled to GND by discharging resistor R5. Since the Reset* input of the electronic chip 124 is an active low input, node N5 being low causes the electronic chip 124 to remain in reset. While the electronic chip 124 is in reset, the counter 140 does not advance even though power has been applied to the electronic chip 124.

The battery 122 also charges capacitor C2 through transistor Q1 and resistor R3. Charging the capacitor C2 drives (at 408) the voltage at node N5 to a high voltage level determined by the voltage divider formed by resistors R3 and R5. The time to charge capacitor C2 is determined based on the time constant determined by the resistance of R3 and the capacitance of C2 (R3 and C2 form an RC circuit). Effectively, resistor R3 and capacitor C2 form a delay circuit connected to the Reset* input of the electronic chip 124. The delay circuit maintains the electronic chip 124 in reset for a delay interval (based on the time constant of the RC circuit formed from R3 and C2) after the power up. While the electronic chip 124 is in reset, the counter 140 is prevented from advancing.

Once N5 is driven to a high voltage level at time T3 due to charging of capacitor C2, the Reset* input is de-asserted high, which releases the electronic chip 124 from reset. As a result, the counter 140 of the electronic chip 124 advances (at 410), to track an occurrence of the opening of the cover 112.

Capacitor C1 is charged through resistors R1 and R2. The time to charge capacitor C1 is determined based on the time constant determined by the combined resistance of R1 and R2 and the capacitance of C1 (R1, R2, and C1 form an RC circuit that implements a delay circuit). Charging capacitor C1 drives (at 412) node N4 high. When node N4 reaches a high voltage level at time T2, transistor Q2 is activated to pull (at 414) node N3 low to GND, which deactivates transistor Q1. The delay circuit including R1, R2, and C1 delays the activation of transistor Q2.

When transistor Q2 is activated and transistor Q1 is deactivated, node N2 is disconnected from the battery 122. As a result, discharging resistor R5 pulls (at 416) node N5 (and thus Reset*) low to GND. The electronic chip 124 is again placed in reset. Node N5 being pulled low also causes node N6 to be pulled low (at 418).

Once the cover 112 is closed and the switch 120 is opened at time T5, no power is supplied to node N4, at which point discharging resistor R4 can pull (at 420) node N4 low to GND.

The counter 140 can advance as many times as the cover 112 is opened. The count of the counter 140 can be accessed by the management controller 108.

In a second example, it is assumed VCC is applied (due to the primary power supply 130 being on). As a result, diode D2 activates and node N6 is set to VCC less the threshold voltage of diode D2. When the cover 112 is opened and the switch 120 is actuated to the closed state, the states of nodes N3, N4, and N5 follow similar patterns as shown in FIG. 4. The counter 140 is advanced in response to de-assertion of the Reset* input due to node N5 being de-asserted high (similar to transition 408 in FIG. 4).

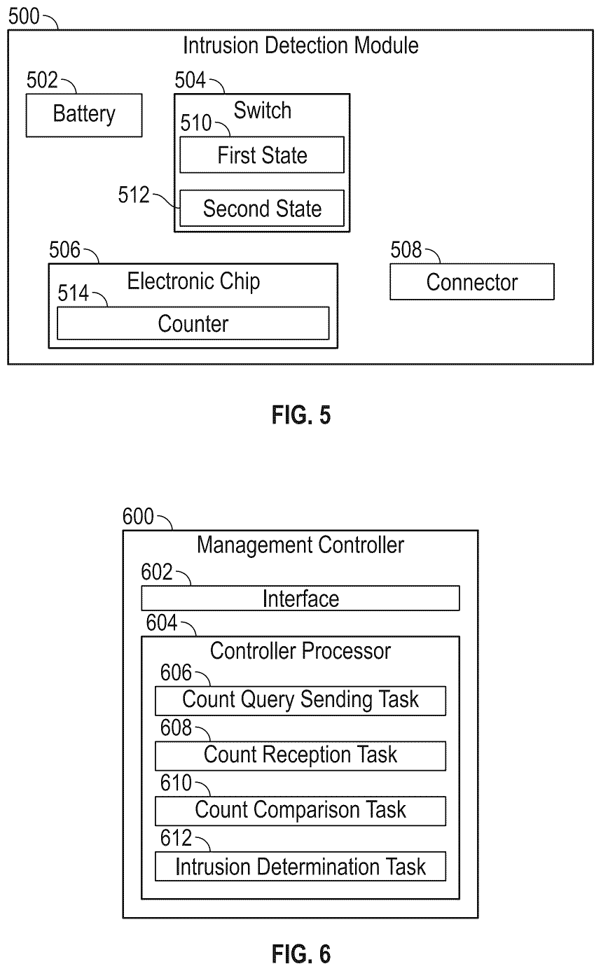

FIG. 5 is a block diagram of an intrusion detection module 500 according to some examples of the present disclosure. An example of the intrusion detection module 500 is the intrusion detection module 110 of FIG. 1.

The intrusion detection module 500 includes a battery 502, a switch 504, an electronic chip 506, and a connector 508. The battery 502, the switch 504, the electronic chip 506, and the connector 508 are contained within a package that houses the components of the intrusion detection module 500.

The switch 504 has a first state 510 and a second state 512, where the first state 510 corresponds to a removable cover of an electronic device being closed, and the second state 512 corresponds to the removable cover of the electronic device being open. The first state 510 may be an open state of the switch 504, and the second state 512 may be a closed state of the switch 504.

The electronic chip 506 includes a counter 514. The counter 514 advances (increments or decrements) based on the switch 504 transitioning from the first state 510 to the second state 512 to connect power from the battery 502 to the electronic chip 506.

A count of the counter 514 is accessible through the connector 508 to a controller in the electronic device. An example of the controller is the management controller 108 of FIG. 1. The count when different from an expected value (e.g., the expected count 166 of FIG. 1) indicates an occurrence of a physical intrusion of the electronic device.

In some examples, the counter 514 advances responsive to a power up of the electronic chip 506.

In some examples, the electronic chip 506 has a reset input (e.g., the Reset* input of FIG. 3). The intrusion detection module 500 further includes a delay circuit connected to the reset input to maintain the electronic chip 506 in reset for a delay interval after the power up, where while the electronic chip 506 is in reset the counter 514 is prevented from advancing. An example of the delay circuit is an RC circuit (e.g., including resistor R3 and capacitor C2 in FIG. 3).

In some examples, electrical current flows from the battery 502 to charge the capacitor through the resistor of the RC circuit when the switch 504 transitions to the second state 512.

In some examples, the reset input is asserted during the delay interval. After the delay interval, the reset input is de-asserted to allow the counter 514 to advance.

In some examples, the intrusion detection module 500 includes a transistor when activated triggers assertion of the reset input of the electronic chip 506 after the advance of the counter 514. The assertion of the reset input places the electronic chip 506 in reset. An example of the transistor is transistor Q2 in FIG. 3.

In some examples, the transistor when activated causes a disconnection of the battery 502 from the reset input.

In some examples, the connector 508 includes a power contact (e.g., VCC contact) to receive a power supply voltage from the electronic device. The power contact is connected to the electronic chip 506.

In some examples, the intrusion detection module 500 includes a diode (e.g., diode D2 in FIG. 3) between the battery 502 and the power contact of the connector 508.

In some examples, the electronic chip 506 includes a nonvolatile memory (e.g., 142 in FIG. 1) to store a secret (e.g., a private key). The electronic chip 506 includes a chip processor (e.g., 146 in FIG. 1) to use the secret in generating an authentication value used in authenticating the module by the controller. The authentication value may be a signed value generated by signing a challenge value (including a nonce and possibly one or more other values).

FIG. 6 is a block diagram of a management controller 600 for an electronic device. An example of the management controller 600 is the management controller 108 of FIG. 1.

The management controller 600 includes an interface 602 to communicate with an intrusion detection module (e.g., 110 in FIG. 1). The interface 602 may be a bus interface to communicate over a bus (e.g., the management bus 128 of FIG. 1. The intrusion detection module includes a battery, a switch, and an electronic chip, where the switch has an open state corresponding to a cover of the electronic device being closed, and a closed state corresponding to the cover of the electronic device being open.

The management controller 600 includes a controller processor 604 to perform various tasks. The tasks of the controller processor 604 include a count query sending task 606 to send a query to the electronic chip for a count of a counter in the electronic chip, the counter to advance based on the switch transitioning from the open state to the closed state to connect power from the battery to the electronic chip.

The tasks of the controller processor 604 include a count reception task 608 to receive the count from the electronic chip. The count is received in response to the query.

The tasks of the controller processor 604 include a count comparison task 610 to compare the count from the electronic chip to an expected count (e.g., 166 in FIG. 1). The expected count represents how many (zero or more) authorized intrusions into the electronic device have occurred.

The tasks of the controller processor 604 include an intrusion determination task 612 to determine whether an intrusion into the electronic device has occurred based on the comparing. An intrusion is detected if the count from the electronic chip exceeds the expected count.

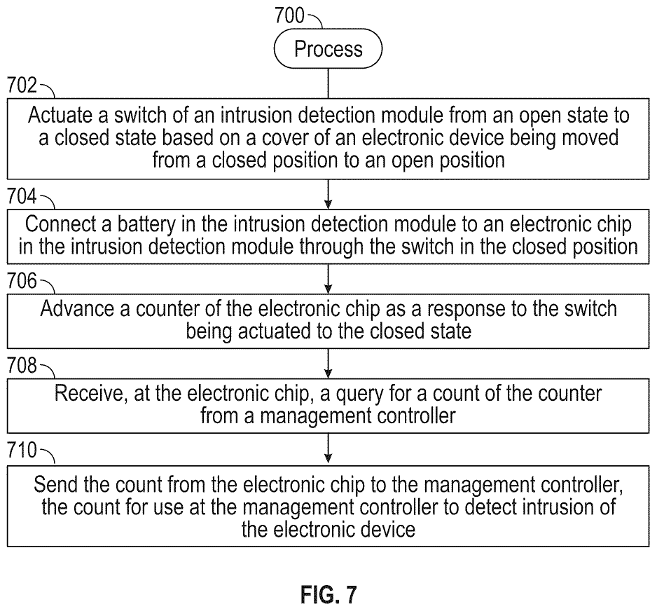

FIG. 7 is a flow diagram of a process 700 according to some examples. The process 700 includes actuating (at 702) a switch of an intrusion detection module from an open state to a closed state based on a cover of an electronic device being moved from a closed position to an open position. The switch of the intrusion detection module may be mechanically linked to the cover.

The process 700 includes connecting (at 704) a battery in the intrusion detection module to an electronic chip (e.g., 124 in FIG. 1) in the intrusion detection module through the switch in the closed position. Connecting the battery to the electronic chip may be accomplished through one or more circuits, such as transistor Q1 and diode D1 in FIG. 3.

The process 700 includes advancing (at 706) a counter of the electronic chip as a response to the switch being actuated to the closed state. The counter can advance when power is applied to the electronic chip and the electronic chip is released from reset.

The process 700 includes receiving (at 708), at the electronic chip, a query for a count of the counter from a management controller (e.g., 108 in FIG. 1). The process 700 includes sending (at 710) the count from the electronic chip to the management controller, the count for use at the management controller to detect intrusion of the electronic device.

As used here, a “CPU” can include one or more hardware processors. A hardware processor (or processor) can include a microprocessor, a core of a multi-core microprocessor, a microcontroller, a programmable integrated circuit, a programmable gate array, or another hardware processing circuit.

An “electronic device” can refer to any or some combination of the following: a desktop computer, a notebook computer, a tablet computer, a smartphone, a server computer, a communication system, a storage system, a game appliance, a household appliance, a vehicle, or any other type of electronic device.

A “memory” can be implemented with one or more memory devices. A memory device includes a dynamic or static random access memory (a DRAM or SRAM) device, an erasable and programmable read-only memory (EPROM) device, an electrically erasable and programmable read-only memory (EEPROM) device, or a flash memory device.

A “BMC” can refer to a specialized service controller that monitors the physical state of an electronic device using sensors and communicates with a remote management system (that is remote from the electronic device) through an independent “out-of-band” connection. The BMC can perform management tasks to manage components of the electronic device. Examples of management tasks that can be performed by the BMC can include any or some combination of the following: power control to perform power management of the electronic device (such as to transition the electronic device between different power consumption states in response to detected events), thermal monitoring and control of the electronic device (such as to monitor temperatures of the electronic device and to control thermal management states of the electronic device), fan control of fans in the electronic device, system health monitoring based on monitoring measurement data from various sensors of the electronic device, remote access of the electronic device (to access the electronic device over a network, for example), remote reboot of the electronic device (to trigger the electronic device to reboot using a remote command), system setup and deployment of the electronic device, system security to implement security procedures in the electronic device, and so forth.

In some examples, the BMC can provide so-called “lights-out” functionality for an electronic device. The lights out functionality may allow a user, such as a systems administrator, to perform management operations on the electronic device even if an OS is not installed or not functional on the electronic device.

Moreover, in some examples, the BMC can run on auxiliary power provided by an auxiliary power source (e.g., 132 in FIG. 1); as a result, the electronic device does not have to be powered on to allow the BMC to perform the BMC's operations. The auxiliary power source is separate from a primary power supply (e.g., 130 in FIG. 1) that supplies powers to other components (e.g., a main processor, a memory, an I/O device, etc.) of the electronic device.

In some examples, tasks may be performed by machine-readable instructions executed by a processing resource. The machine-readable instructions may be stored in a storage medium, which can include any or some combination of the following: a semiconductor memory device such as a DRAM or SRAM, an EPROM, an EEPROM, or a flash memory; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the present disclosure, use of the term “a,” “an,” or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A module comprising:
a battery;
a switch comprising a first state and a second state, the first state corresponding to a removable cover of an electronic device being closed, and the second state corresponding to the removable cover of the electronic device being open;
an electronic chip comprising a counter, the counter to advance based on the switch transitioning from the first state to the second state to connect power from the battery to the electronic chip; and
a connector, wherein a count of the counter is accessible through the connector to a controller in the electronic device, the count when different from an expected value indicating an occurrence of a physical intrusion of the electronic device.

2. The module of claim 1, comprising a package, wherein the battery, the switch, and the electronic chip are housed within the package.

3. The module of claim 1, wherein the counter is to advance responsive to a power up of the electronic chip.

4. The module of claim 3, wherein the electronic chip comprises a reset input, the module further comprising:
a delay circuit connected to the reset input to maintain the electronic chip in reset for a delay interval after the power up, wherein while the electronic chip is in reset the counter is prevented from advancing.

5. The module of claim 4, wherein the delay circuit comprises a capacitor and a resistor through which electrical current flows from the battery to charge the capacitor when the switch transitions to the second state.

6. The module of claim 4, wherein the reset input is asserted during the delay interval, and wherein after the delay interval the reset input is de-asserted to allow the counter to advance.

7. The module of claim 6, further comprising:
a transistor when activated to trigger assertion of the reset input after the advance of the counter, the assertion of the reset input to place the electronic chip in reset.

8. The module of claim 7, wherein the transistor when activated is to further cause a disconnection of the battery from the reset input.

9. The module of claim 1, wherein the connector comprises a power contact to receive a power supply voltage from the electronic device, and wherein the power contact is connected to the electronic chip.

10. The module of claim 9, further comprising a diode between the battery and the power contact of the connector.

11. The module of claim 1, wherein the electronic chip further comprises:
a nonvolatile memory to store a secret; and
a chip processor to use the secret in generating an authentication value used in authenticating the module by the controller.

12. The module of claim 11, wherein the secret comprises a private key, and the chip processor is to:
sign, using the private key, information of a challenge from the controller, and
send, from the module, the signed information to the controller as part of the authenticating.

13. The module of claim 1, wherein the switch is mechanically linked to the removable cover.

14. A management controller for an electronic device, comprising:
an interface to communicate with an intrusion detection module comprising a battery, a switch, and an electronic chip, wherein the switch has an open state corresponding to a cover of the electronic device being closed, and a closed state corresponding to the cover of the electronic device being open; and
a controller processor to:
send a query to the electronic chip for a count of a counter in the electronic chip, the counter to advance based on the switch transitioning from the open state to the closed state to connect power from the battery to the electronic chip,
receive the count from the electronic chip,
compare the count from the electronic chip to an expected count, and
determine whether an intrusion into the electronic device has occurred based on the comparing.

15. The management controller of claim 14, further comprising a memory to store the expected count, the expected count indicating how many authorized openings of the cover of the electronic device has occurred.

16. The management controller of claim 14, wherein the controller processor is to:
initiate an authentication process to authenticate the electronic chip, and
initiate an intrusion detection process based on the electronic chip being authenticated in the authentication process, the intrusion detection process comprising the sending of the query, the receiving of the count, the comparing of the count, and the determining of whether the intrusion has occurred.

17. The management controller of claim 16, wherein the controller processor is to:
as part of the authentication process, send a challenge to the electronic chip,
receive a challenge response from the electronic chip, the challenge response containing an authentication value derived using a secret in the electronic chip, and
authenticate the electronic chip using the authentication value.

18. A method comprising:
actuating a switch of an intrusion detection module from an open state to a closed state based on a cover of an electronic device being moved from a closed position to an open position;
connecting a battery in the intrusion detection module to an electronic chip in the intrusion detection module through the switch in the closed position;
advancing a counter of the electronic chip as a response to the switch being actuated to the closed state;
receiving, at the electronic chip, a query for a count of the counter from a management controller; and
sending the count from the electronic chip to the management controller, the count for use at the management controller to detect intrusion of the electronic device.

19. The method of claim 18, further comprising:
maintaining the electronic chip in reset for a time delay following the connecting of the battery to the electronic chip; and
after the time delay, releasing the electronic chip from reset, wherein the counter advances after the electronic chip is released from reset.

20. The method of claim 18, further comprising:
as part of an authentication process, generating, by the electronic chip, an authentication value based on a secret stored in the electronic chip; and
sending the authentication value to the management controller for use in authenticating the electronic chip by the management controller.
